(19) United States
(12) Patent Application Publication
(10) Pub. No.: US 2015/0299427 A1
(43) Pub. Date: Oct. 22, 2015

(54) MELAMINE FREE COMPOSITE ADDITIVE FOR POLYOXYMETHYLENE

(71) Applicant: FDC,LEES CHEMICAL INDUSTRY CO., LTD., TAIPEI CITY (TW)

(72) Inventors: SHU-HUNG HSIEH, NEW TAIPEI CITY (TW); CHEN-KAI CHEN, TAIPEI CITY (TW); KUN-CHANG LEE, TAIPEI CITY (TW)

(21) Appl. No.: 14/503,542

(22) Filed: Oct. 1, 2014

(30) Foreign Application Priority Data
Apr. 18, 2014 (TW) 103114198

(51) Int. Cl. C08K 5/3492; C08K 5/103; C08K 5/13; C08K 5/20; C08K 5/3435; C08K 5/134

(52) U.S. Cl. CPC C08K 5/34924; C08K 5/3435; C08K 5/134; C08K 5/13; C08K 5/20; C08K 5/103

(57) ABSTRACT

A melamine free composite additive used in polyoxymethylene is provided. The composite additive includes an amine stabilizer and antioxidant. The composition of the amine stabilizer is 0.01 to 3 parts by weight per 100 parts by weight of the polyoxymethylene. The composition of the antioxidant is 0.05 to 3 parts by weight per 100 parts by weight of the polyoxymethylene. The composite additive enhances the light stability and thermal stability of the polyoxymethylene.

### BACKGROUND OF THE INVENTION

1. Field of the Invention

The instant disclosure relates to a composite additive including an antioxidant and a light stabilizer; in particular, to a composite additive including an antioxidant and a light stabilizer used in a polyoxymethylene.

2. Description of Related Art

The polyoxymethylene is a polymer with high crystallinity and high melting point. However, the thermal stability of the polyoxymethylene is poor. While the polyoxymethylene is heated, the formaldehyde, the formic acid, or other substance with small molecular weight is released to cause plastic pyrolysis. In the industry, the method of the copolymerization is widely used to modify the polyoxymethylene, so as to enhance the thermal stability of the polyoxymethylene. For example, the polyoxymethylene can be copolymerized with the compound having the cyclic ethers. The C—C copolymer chain of the copolymer enhances the thermal stability of the polyoxymethylene. In Europe patent EP. 128739(1984), the polyoxymethylene is copolymerized with the trioxane.

In addition, the hydroxyl group at the terminal of the polyoxymethylene can be substituted with the ether group or the ester group, so as to decrease the heating pyrolysis of the polyoxymethylene. In U.S. Pat. No. 4,097,453, the unstable hydroxyl group of the polyoxymethylene is etherified to enhance the thermal stability of the polyoxymethylene.

Nevertheless, the polyoxymethylene can still autoxidize even after copolymerizing with compound or substituting with the ether group. The present research indicates that the radical generated in the heating process causes the autoxidation of the polyoxymethylene. Thus, controlling the generation of the radical becomes an important method to enhance the thermal stability of the polyoxymethylene.

### SUMMARY OF THE INVENTION

The present invention provides a melamine free composite additive used in the polyoxymethylene. The composite additive enhances the light stability and the thermal stability of the polyoxymethylene.

The present invention provides a melamine free composite additive used in polyoxymethylene. The composite additive includes an amine stabilizer and an antioxidant. The composition of the amine stabilizer is 0.01 to 3.0 parts by weight per 100 parts by weight of the polyoxymethylene. The composition of the antioxidant is 0.05 to 3.0 parts by weight per 100 parts by weight of the polyoxymethylene. The composite additive used in the polyoxymethylene can enhance the light stability and the thermal stability of the polyoxymethylene.

To sum up, the present invention provides the melamine free composite additive used in the polyoxymethylene. The composite additive includes the amine stabilizer and the antioxidant. The antioxidant stabilizes the radical generated in the heating process of the polyoxymethylene. Thus, the thermal stability of the polyoxymethylene is enhanced. In addition, the amine stabilizer can eliminate the radical formed in the heating process to stabilize the antioxidant of the composite additive.

In order to further understand the instant disclosure, the following embodiments and illustrations are provided. However, the detailed description is merely illustrative of the disclosure, rather than limiting the scope being defined by the appended claims and equivalents thereof.

### DETAILED DESCRIPTION OF THE PREFERRED EMBODIMENTS

The present invention provides a melamine free composite additive used in a polyoxymethylene. The composite additive includes an amine stabilizer, an antioxidant, an antacid, and a lubricant.

The composition of the antioxidant is 0.05 to 3.0 parts by weight per 100 parts by weight of the polyoxymethylene. The antioxidant is selected from the group consisting of: four(β_(3,5-di-tert-butyl-4-hydroxyphenyl) propionate)pentaerythritol ester (referred to as an antioxidant 1010); triethylene glycol-ether-bis-(3-tert-butyl-4-hydroxy-5-methylphenyl) propionate (referred to as an antioxidant 245); 1,3,5-trimethyl-2,4,6-tris-(3,5-di-tert-butyl-4-hydroxybenzyl)benzene (referred to as an antioxidant 1330); 1,3,5-tris(3,5-di-tert-butyl-4-hydroxybenzyl) isocyanurate (referred to as an antioxidant 3114); 1,1,3-tris-(2-methyl-4-hydroxy-5-tert-butylphenyl)butane; 4,4′-butylidene-bis(6-tert-butyl-3-methyl phenol) (referred to as an antioxidant AO-30); N,N′-bis[β(3,5-di-tert-butyl-4-hydroxyphenyl)propan-acyl]-hydrazine (referred to as an antioxidant 1024); N,N′-bis-(3-(3,5-di-tert-butyl-4-hydroxyphenyl)-propan-acyl)-hexam-ethylenediamine; 2,2-methylene-bis-(4-methyl-6-tert-butylphenol) (referred to as an antioxidant 1098); 3,5-di-tert-butyl-4-hydroxyphenyl propionic acid isooctyl ester (referred to as an antioxidant 1135); a first composite structural stabilizer; and a second composite structural stabilizer.

Specifically, the general formula of the first composite structural stabilizer is shown as below:

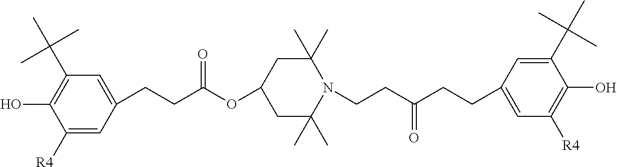

R4 of the above general formula is selected from the group consisting of methyl group and tertbutyl group. The first composite structural stabilizer with the methyl group is referred to as a composite structure 2462. The first composite structural stabilizer with the tertbutyl group is referred to as a composite structure 1062. In addition, the general formula of the second composite structural stabilizer is shown as below:

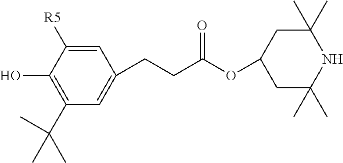

R5 of the above general formula is selected from the group consisting of methyl group and tertbutyl group. The second composite structural stabilizer with the methyl group is referred to as a composite structure 2477. The second composite structural stabilizer with the tertbutyl group is referred to as a composite structure 1077.

In the preferred embodiment, the antioxidant can be the antioxidant 245, the antioxidant 1010, the antioxidant1 1330, the antioxidant 3114, the composite structure 1077, the composite structure 2462 or the composite structure 1062. It is worth noting that, the antioxidant can stabilize the radical generated in the heating process of the polyoxymethylene. The radical causing the pyrolysis of the polyoxymethylene is stabilized by adding the antioxidant. Thus, the thermal stability of the polyoxymethylene is enhanced. In addition, both the first and the second composite structural stabilizers containing the hindered amine functional group are taken as the antioxidant and the hindered phenol functional group are taken as the light stabilizer. Hence, both the first and the second composite structural stabilizers enhance the thermal stability and the light stability of the polyoxymethylene.

Moreover, the composition of the amine stabilizer is 0.01 to 3.0 parts by weight per 100 parts by weight of the polyoxymethylene. The amine stabilizer is selected from the group consisting of: sebacic acid, bis(1,2,2,6,6-pentamethyl-4-piperidinyl) ester (referred to as a light stabilizer 292); bis(1-octyloxy-2,2,6,6-tetramethyl-4-piperidyl)sebacate (referred to as a light stabilizer 523); bis(2,2,6,6-tetramethyl-4-piperidyl) sebacate (referred to as a light stabilizer 770); 1,5,8,12-tetrakis[4,6-bis-(N-butyl-N-1,2,2,6,6-pentamethyl-4-piperidylamino)-1,3,5-triazin-2-yl]-1,5,8,12-tetraazadodecane (referred to as a light stabilizer 119); polylactic acid(4-hydroxy-2,2,6,6-tetramethyl-1-piperidine-ethanol)-ester (referred to as a light stabilizer 622); poly[[6-[(1,1,3,3-tetramethyl-butyl)amino]-1,3,5-triazine-2,4-diyl][(2,2,6,6-tetramethyl-4-piperidyl)imino]1,6-diyl, [(2,2,6,6-tetramethyl-4-piperidyl)imino]] (referred to as a light stabilizer 944); N,N′-bis(2,2,6,6-tetramethyl-4-piperidyl)-N,N′-dialdehyde-hexamethylene-diamine (referred to as a light stabilizer 945); [[3,5-di-tert-butyl-4-hydroxyphenyl]methyl]butyl-malonate, (1,2,2,6,6-pentamethyl-4-piperidinyl) ester (referred to as a light stabilizer 5144); 2,9,11,13,15,22,24,26,27,28,-azatricyclo(21.31110.14)octacosanyl-1(27),10,12,14(28),23,25-hexaene-12,25-diamine; N,N′-bis(1,1,3,3-tetramethyl butyl)-2,9,15,22-four(2,2,6,6-tetramethyl-4-piperidyl) (referred to as a light stabilizer 966); 2-methyl-2-propenoic acid-1,2,2,4,6-pentamethyl-4-piperidinyl ester (referred to as a light stabilizer LA82); poly[(6-morpholino-1,3,5-triazine2,4-yl)-((2,2,6,6-tetramethyl-4-piperidyl)imino)hexane-((2,2,6,6-tetramethyl-4-piperidyl)imino)] (referred to as a light stabilizer 3346); and a dialkyl hydroxylamine extension.

In the preferred embodiment, the amine stabilizer can be the light stabilizer 944, the light stabilizer 622, the light stabilizer 770, the light stabilizer 119, the light stabilizer LA82, the light stabilizer 3346 or the dialkyl hydroxylamine extension. Specifically, the general formula of the dialkyl hydroxylamine extension is shown as below:

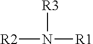

In the above formula, R1 is selected from the group consisting of C4 to C18, R2 is selected from the group consisting of C4 to C18, and R3 is selected from the group consisting of OH and H. In the preferred embodiment, the dialkyl hydroxylamine extension can be the dioctadecyl-hydroxylamine. In other words, both R1 and R2 are C18 and R3 is OH. It is worth noting that, the hindered amine functional group of the amine stabilizer can enhance the light stability of the polyoxymethylene and hinder the chain reaction of the radical. Thus, the amine stabilizer can stabilize the polyoxymethylene. In addition, the hydroxylamine structure of the dialkyl hydroxylamine extension can eliminate the radical generated in the heating process. Therefore, the antioxidant can also be stabilized.

Moreover, in the present embodiment of the invention, the melamine free composite additive further includes the antacid and the lubricant. The composition of the antacid is 0.05 to 0.3 parts by weight per 100 parts by weight of the polyoxymethylene. The antacid is selected from the group consisting of the stearate and the hydrotalcite. The composition of the lubricant is 0.05 to 0.3 parts by weight per 100 parts by weight of the polyoxymethylene. The lubricant is selected from the group consisting of N,N′-Ethylenebis(stearamide) (referred to as a EBS), glyceryl monostearate (referred to as a GMS), and pentaerythritol stearate (referred to as a PETS).

In the following paragraphs, the composite additives with different composition and different species of the amine stabilizer, the antioxidant, the antacid, and the lubricant are mixed with the polyoxymethylene to manufacture several polyoxymenthylene complexes as embodiments. In addition, several comparative examples are manufactured to introduce the efficiency of the composite additive. It is worth noting that, the composition is utilized to illustrate the embodiment, the present invention is not limited thereto.

### Embodiment 1

In the embodiment 1 of the present invention, the amine stabilizer is light stabilizer 770, the antioxidant is antioxidant 245, the antacid is hydrotalcite, and the lubricant is EBS. The composition of the polyoxymethylene, the antioxidant 245, the light stabilizer 770, the hydrotalcite, and the EBS are 100, 0.45, 0.1, 0.2, and 0.1 in parts by weight, respectively.

The manufacturing method of the polyoxymethylene complex includes the following steps. Firstly, the above components are well mixed and added to the twin screw extrusion machine to extrude. The extrusion machine has thirteen individual stages of temperature settings which are 180° C., 200° C., 200° C., 200° C., 200° C., 200° C., 200° C., 200° C., 200° C., 200° C., 200° C., 200° C., and 180° C. The rotational speed of the main screw is 200 rpm, and the residence time of the polyoxymethylene complex is 30 seconds. Then, the compound extruded from the machine is cooled, air dried, diced, and dried to manufacture a polyoxymethylene complex particle with the melamine free composite additive.

### Embodiment 2

In the embodiment 2 of the present invention, the amine stabilizer is light stabilizer 944. The antioxidant is the combination of antioxidant 1010 and composite structure 2462. The antacid is hydrotalcite and the lubricant is EBS. The composition of the polyoxymethylene, the light stabilizer 944, the antioxidant 1010, the composite structure 2462, the hydrotalcite, and the EBS are 100, 0.05, 0.3, 0.2, 0.2, and 0.1 parts by weight, respectively. In addition, the manufacturing method of the polyoxymethylene complex in the embodiment 2 is the same as the embodiment 1, and is omitted thereto.

### Embodiment 3

In the embodiment 3 of the present invention, the amine stabilizer is the combination of dioctadecyl-hydroxylamine and light stabilizer 3346. The antioxidant is antioxidant 1330, the antacid is hydrotalcite, and the lubricant is GMS. The composition of the polyoxymethylene, the dioctadecyl-hydroxylamine, the antioxidant 1330, the light stabilizer 3346, the hydrotalcite, and the GMS are 100, 0.05, 0.45, 0.05, 0.2, and 0.1 parts by weight, respectively. In addition, the manufacturing method of the polyoxymethylene complex in the embodiment 3 is the same as the embodiment 1, and is omitted thereto.

### Embodiment 4

In the embodiment 4 of the present invention, the amine stabilizer is light stabilizer 119, the antioxidant is antioxidant 1062, the antacid is hydrotalcite, and the lubricant is PETS. The composition of the polyoxymethylene, the antioxidant 1062, the light stabilizer 119, the hydrotalcite, and the PETS are 100, 0.4, 0.15, 0.2, and 0.1 parts by weight, respectively. In addition, the manufacturing method of the polyoxymethylene complex in the embodiment 4 is the same as the embodiment 1, and is omitted thereto.

### Embodiment 5

In the embodiment 5 of the present invention, the amine stabilizer is light stabilizer LA82, the antioxidant is antioxidant 3114, the antacid is hydrotalcite, and the lubricant is EBS. The composition of the polyoxymethylene, the light stabilizer LA82, the antioxidant 3114, the hydrotalcite, and the EBS are 100, 0.25, 0.3, 0.2, and 0.1 parts by weight, respectively. The manufacturing method of the polyoxymethylene complex in the embodiment 5 is the same as the embodiment 1, and is omitted thereto.

### Embodiment 6

In the embodiment 6 of the present invention, the amine stabilizer is dioctadecyl-hydroxylamine, the antioxidant is antioxidant 1010, the antacid is hydrotalcite, and the lubricant is GMS. The composition of the polyoxymethylene, the dioctadecyl-hydroxylamine, the antioxidant 1010, the hydrotalcite, and the GMS are 100, 0.13, 0.42, 0.2, and 0.1 parts by weight, respectively. Moreover, the manufacturing method of the polyoxymethylene complex in the embodiment 6 is the same as the embodiment 1, and is omitted thereto.

### Embodiment 7

In the embodiment 7 of the present invention, the amine stabilizer is the combination of dioctadecyl-hydroxylamine and light stabilizer 622. The antioxidant is antioxidant 1010, the antacid is hydrotalcite, and the lubricant is EBS. The composition of the polyoxymethylene, the dioctadecyl-hydroxylamine, the light stabilizer 622, the antioxidant 1010, the hydrotalcite, and the EBS are 100, 0.08, 0.08, 0.39, 0.2, and 0.1 parts by weight, respectively. Moreover, the manufacturing method of the polyoxymethylene complex in the embodiment 7 is the same as the embodiment 1, and is omitted thereto.

### Embodiment 8

In the embodiment 8 of the present embodiment, the amine stabilizer is dioctadecyl-hydroxylamine, the antioxidant is composite structure 1077, the antacid is hydrotalcite, and the lubricant is PETS. The composition of the polyoxymethylene, the dioctadecyl-hydroxylamine, the composite structure 1077, the hydrotalcite, and the PETS are 100, 0.05, 0.5, 0.2, and 0.1 parts by weight, respectively. Moreover, the manufacturing method of the polyoxymethylene complex in the embodiment 7 is the same as the embodiment 1, and is omitted thereto. The compositions of the above mentioned embodiments 1-8 are listed as Table 1:

TABLE 1

| Composition | Poly- | | Amine | | |
|---|---|---|---|---|---|
| (parts by | oxymeth- | Antiox- | stabi- | Ant- | Lubri- |
| weight) | ylene | idant | lizer | acid | cant |
| embodiment 1 | 100 | 0.45 | 0.1 | 0.2 | 0.1 |
| embodiment 2 | 100 | 0.5 | 0.05 | 0.2 | 0.1 |
| embodiment 3 | 100 | 0.45 | 0.1 | 0.2 | 0.1 |
| embodiment 4 | 100 | 0.4 | 0.15 | 0.2 | 0.1 |
| embodiment 5 | 100 | 0.3 | 0.25 | 0.2 | 0.1 |
| embodiment 6 | 100 | 0.42 | 0.13 | 0.2 | 0.1 |
| embodiment 7 | 100 | 0.39 | 0.16 | 0.2 | 0.1 |
| embodiment 8 | 100 | 0.5 | 0.05 | 0.2 | 0.1 |

### Comparative Example 1

In the comparative example 1, the antioxidant is antioxidant 245, the antacid is hydrotalcite, and the lubricant is EBS. In addition, the additive in the comparative example 1 further includes an anti-aldehyde agent, which is melamine in the present example. The composition of the polyoxymethylene, the antioxidant 245, the melamine, the hydrotalcite, and the EBS are 100, 0.4, 0.15, 0.2, and 0.1 parts by weight, respectively. In addition, the manufacturing method of the polyoxymethylene complex in the comparative example 1 is the same as the embodiment 1, and is omitted thereto.

### Comparative Example 2

In the comparative example 2, the antioxidant is antioxidant 1010, the antacid is hydrotalcite, and the lubricant is GMS. The additive in the comparative example 2 further includes the melamine. The composition of the polyoxymethylene, the antioxidant 1010, the melamine, the hydrotalcite, and the GMS are 100, 0.5, 0.05, 0.2 and 0.1 parts by weight, respectively. In addition, the manufacturing method of the polyoxymethylene complex in the comparative example 2 is the same as the embodiment 1, and is omitted thereto.

### Comparative Example 3

In the comparative example 3, the antioxidant is antioxidant 3114, the antacid is hydrotalcite, and the lubricant is GMS. In addition, the additive in the comparative example 3 further includes the melamine. The composition of the polyoxymethylene, the antioxidant 3114, the melamine, the hydrotalcite, and the GMS are 100, 0.35, 0.2, 0.2, and 0.1 parts by weight, respectively. In addition, the manufacturing method of the polyoxymethylene complex in the comparative example 3 is the same as the embodiment 1, and is omitted thereto.

### Comparative Example 4

In the comparative example 4, the antioxidant is antioxidant 1330, the antacid is hydrotalcite, and the lubricant is PETS. The comparative example further includes the melamine. The composition of the polyoxymethylene, the antioxidant 1330, the melamine, the hydrotalcite, and the PETS are 100, 0.45, 0.1, 0.2, and 0.1 parts by weight, respectively. In addition, the manufacturing method of the polyoxymethylene complex in the comparative example 4 is the same as the embodiment 1, and is omitted thereto.

It is worth noting that, the composition of the polyoxymethylene complexes in the comparative examples 1-4 are the composition commonly used in the present composite additive. All the composition in the comparative examples 1-4 contains the melamine. The composition of the above mentioned comparative examples 1-4 are listed as Table 2:

TABLE 2

| Composition | Compar- | Compar- | Compar- | Compar- |
|---|---|---|---|---|
| (parts by | ative | ative | ative | ative |
| weight) | example 1 | example 2 | example 3 | example 4 |
| polyoxymethylene | 100 | 100 | 100 | 100 |
| antioxidant | 0.4 | 0.5 | 0.35 | 0.45 |
| Melamine | 0.15 | 0.05 | 0.2 | 0.1 |
| Antacid | 0.2 | 0.2 | 0.2 | 0.2 |
| Lubricant | 0.1 | 0.1 | 0.1 | 0.1 |

After synthesized, the polyoxymethylene complexes of embodiments 1-8 and comparative examples 1-4 are analyzed by the weight loss test to introduce the efficiency of the composite additives in the present invention. Specifically, the weight loss test includes the following steps. Firstly, the synthesized polyoxymethylene complexes particles of the above mentioned embodiments 1-8 and comparative examples 1-4 are settled in the constant temperature oven for 60 minutes. The temperature of the oven is 230° C. Then, the particles are taken out to calculate the weight loss. The weight loss of the embodiments 1-8 are listed as Table 3, and the weight loss of the comparative examples 1-4 are listed as Table 4.

TABLE 3

| | Weight loss |
|---|---|
| Composition | (60 min, %) |
| embodiment 1 | 3.01 |
| embodiment 2 | 2.14 |
| embodiment 3 | 1.97 |
| embodiment 4 | 2.55 |
| embodiment 5 | 3.75 |
| embodiment 6 | 3.21 |
| embodiment 7 | 2.04 |
| embodiment 8 | 2.46 |

TABLE 4

| | comparative | comparative | comparative | comparative |
|---|---|---|---|---|
| Composition | example 1 | example 2 | example 3 | example 4 |
| Weight loss | 4.87 | 4.55 | 5.97 | 4.01 |
| (60 min, %) | | | | |

Table 3 is the result of weight loss of embodiments 1-8. As shown in Table 3, the weight loss of the embodiments 1-8 is less than 4% after 60 minutes of testing. Particularly, in embodiments 2, 3, 7, and 8, all weight losses are less than 2.5%. In other words, the polyoxymethylene complexes in the embodiments 1-8 have well thermal stability. Table 4 is the result of weight losses of comparative examples 1-4. As shown in Table 4, the weight losses of the comparative examples 1-4 are higher than 4.

Comparing the results in Table 3 and Table 4, the weight losses of the embodiments 1-8 are less than the weight losses of the comparative examples 1-4 with melamine. In other words, the melamine free composite additive used in the polyoxymethylene in the present invention can enhance the thermal stability of the polyoxymethylene.

To sum up, the present invention provides the melamine free composite additive used in the polyoxymethylene. The composite additive includes the amine stabilizer, the antioxidant, the antacid, and the lubricant. The antioxidant stabilizes the radical generated in the heating process of the polyoxymethylene. Thus, the thermal stability of the polyoxymethylene is enhanced. In addition, the amine stabilizer can eliminate the radical formed in the heating process to stabilize the antioxidant of the composite additive.

The descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

1. A melamine free composite additive for polyoxymethylene, comprising:
an amine stabilizer, comprising 0.01 to 3 parts by weight per 100 parts by weight of the polyoxymethylene, wherein the amine stabilizer comprises a dialkyl hydroxylamine derivative having the general formula shown as below: 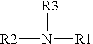
wherein R1 and R2 independently are C18 alkyl and R3 is selected from the group consisting of OH and H; and
an antioxidant, comprising 0.05 to 3 parts by weight per 100 parts by weight of the polyoxymethylene.

2. The composite additive of claim 1, wherein the antioxidant is selected from the group consisting of: four(β_(3,5-di-tert-butyl-4-hydroxyphenyl)propionate), pentaerythritol ester; triethylene glycol ether-bis(3-tert-butyl-4-hydroxy-5-methylphenyl) propionate; 1,3,5-trimethyl-2,4,6-tris(3,5-di-tert-butyl-4-hydroxybenzyl)benzene; 1,3,5-tris(3,5-di-tert-butyl-4-hydroxybenzyl)isocyanurate; 1,1,3-Tris(2-methyl-4-hydroxy-5-tert-butylphenyl)butane; 4,4′-Butylidenebis(6-tert-butyl-3-methylphenol); N,N′-bis[β(3,5-di-tert-butyl-4-hydroxyphenyl)propan-acyl]hydrazine; N,N′-bis-(3-(3,5-di-tert-butyl-4-hydroxyphenyl)propan-acyl)-hexamethylenediamine; 2,2-methylene-bis-(4-methyl-6-tert-butylphenol); and 3,5-di-tert-butyl-4-hydroxyphenyl-propionic-acid isooctyl ester.

3. The composite additive of claim 1, wherein the antioxidant comprises a first composite structural stabilizer having the general formula shown as below: 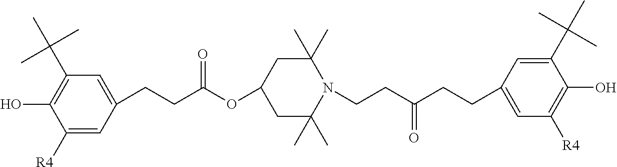
wherein R4 is selected from the group consisting of methyl group and tertbutyl group.

4. The composite additive of claim 1, wherein the antioxidant comprises a first composite structural stabilizer having the general formula shown as below: 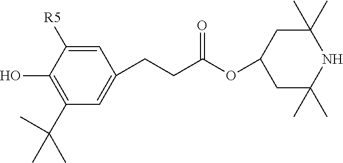
wherein R5 is selected from the group consisting of methyl group and tertbutyl group.

5. (canceled)

6. (canceled)

7. The composite additive of claim 1, wherein the composite additive further comprises an antacid, the content of the antacid is 0.05 to 0.3 parts by weight per 100 parts by weight of the polyoxymethylene, the antacid is selected from the group consisting of stearate and hydrotalcite.

8. The composite additive of claim 1, wherein the composite additive further comprises a lubricant, the content of the lubricant is 0.05 to 0.3 parts by weight per 100 parts by weight of the polyoxymethylene, the lubricant is selected from the group consisting of N,N′-Ethylenebis(stearamide), glyceryl monostearate, and pentaerythritol stearate.
